(19) United States
(12) Patent Application Publication
(10) Pub. No.: US 2008/0155557 A1
(43) Pub. Date: Jun. 26, 2008

(54) Unified metamodel for web services description

(76) Inventors: Vladislav Bezrukov, Sandhausen (DE); Volker Wiechers, Heidelberg (DE)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(21) Appl. No.: 11/644,807

(22) Filed: Dec. 21, 2006

(51) Int. Cl. G06F 9/455

(52) U.S. Cl. 719/316

(57) ABSTRACT

In one aspect, there is provided a computer-implemented method. The method may include mapping, using a metamodel, one or more WSDL (Web Service Descriptor Language) statements associated with a web service to one or more metamodel objects. The one or more metamodel objects are used to generate a client proxy. The client proxy handles calls from a client application to the web service to enable the client application to call the web service without regard to the one or more WSDL statements. Related systems, apparatus, methods, and/or articles are also described.

### FIELD

The subject matter described herein generally relates to data processing. More particularly, the subject matter described herein relates to a metamodel for web service descriptions.

### BACKGROUND

There is, and will continue to be, advances and changes in how enterprises conduct business. Whether these advances and changes occur through growing competition and globalization, mergers and acquisitions, or a revamping of business models, the key for success will often depend on how quickly the enterprise's information technology (IT) organization can adapt to evolving business needs. Therefore, a major challenge to these enterprises is how they handle change.

For organizations to enable business agility, they must ensure that enterprise applications are not only high-performance business engines driving efficiencies, but also that they become flexible building blocks of future business systems. A recent promising solution has risen in the form of services. A service, such as a Web service or program, represents a self-contained, self-describing piece of application functionality that can be found and accessed by other applications. A service is self-contained because the application using the service does not have to depend on anything other than the service itself, and self-describing because all the information on how to use the service can be obtained from the service itself. The descriptions are centrally stored and accessible through standard mechanisms.

A service may be described by a WSDL (Web Services Description Language) document. WSDL is an XML format (also providing an XML Schema) for describing services as a set of endpoints operating on messages containing either document-oriented or procedure-oriented information. For example, the WSDL description of the service may describe the service (or web service) including how to instantiate the web service, how to interact with the web service, the format of any calls to the web service, and the format of any data sent to the web service. When a client application is developed to interact with the web service, the client application must comply with the WSDL description to interact with the web service. Likewise, the web service should comply with its WSDL description. At present, two specifications specify WSDL (see WSDL version 1.1 and WSDL version 2.0 at www.w3.org).

### SUMMARY

In one aspect, there is provided a computer-implemented method. The method may include mapping, using a metamodel, one or more WSDL (Web Service Description Language) statements associated with a web service to one or more metamodel objects. The one or more metamodel objects may be used to generate a proxy (e.g., a client proxy or a server proxy). The proxy handles calls between a client application and the web service to enable the client application to communicate with the web service via messages without regard to a syntax or a version of the one or more WSDL statements

In some variations, the method further includes receiving a WSDL description of the web service. The one or more metamodel objects may be persisted in a class library (e.g., the proxy itself may include some generated classes, datatypes, etc.). Moreover, the client proxy may be generated based on the one or more metamodel objects. The one or more metamodel objects may be used to generate a server proxy, so that the server proxy can handle calls from the web service to the client application to enable the web service to call the client application without regard to the one or more WSDL statements. The metamodel may include the following entities: a definition entity, an interface entity, an operation entity, a parameter entity, and type system entities (e.g. type definitions and element declarations). The client application may call the web service using the client proxy.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

In some implementations of the subject matter described herein, advantages may be realized including lower cost, better lifecycle stability and more rapid development of client applications and web services since the client application and web service may be implemented without regard to a particular WSDL (Web Service Description Language) version.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

In the drawings,

FIG. 1 depicts a system for using a metamodel for web service descriptions;

FIG. 2 depicts a method for generating proxies using the metamodel;

FIG. 3 depicts the metamodel including metamodel objects (also referred to as entities);

FIG. 4 depicts examples of web service descriptions including mappings form the metamodel to the corresponding WSDL descriptions; and

FIG. 5 depicts an implementation of the metamodel of FIG. 3 in an SAP ABAP system environment.

Like reference symbols in the various drawings indicate like elements.

### DETAILED DESCRIPTION

Web service enablement of client business applications is rapidly becoming a growing challenge when developing applications. In particular, a client application that interacts with a web service may be required to incorporate a wide variety of specifications (e.g., WSDL, WS-*, SOAP (Simple Object Access Protocol), XML Schema), knowledge of updates to the specification (e.g., WSDL 1.1 versus WSDL 2.0), varying interpretations of specifications (e.g., WS-I Basic Profile 1.0.), and various proprietary vendor exchange formats (e.g., COM, BinaryXML, SAP-Features, and the like), all of which impose a significant burden when developing client applications and web services. Moreover, the web service may be described in a WSDL-document-oriented style or in a WSDL-RPC (also referred to as procedure-oriented) style resulting in additional variations to WSDL. The foregoing leads to increased complexity when implementing client applications as well as web service applications (e.g., client and server proxies).

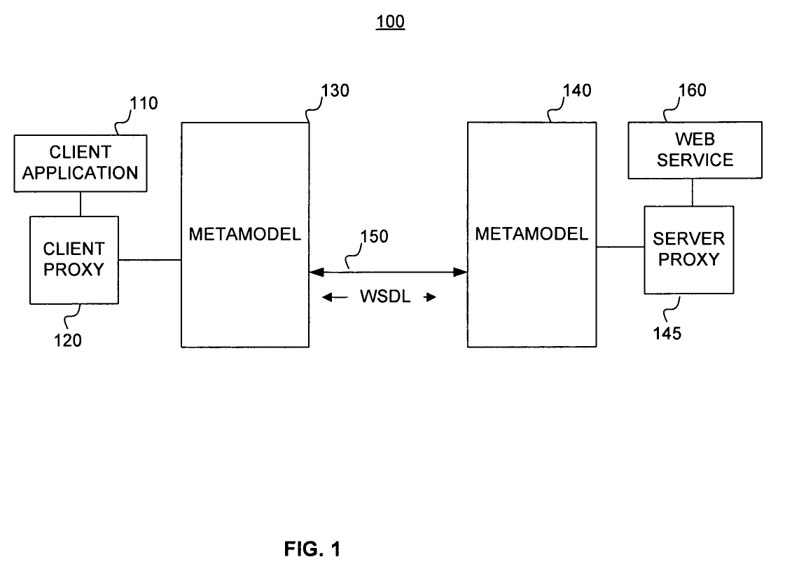

FIG. 1 depicts a system 100 including a client application 110 (e.g., a user interface) for interacting with a web service 160 through a client proxy 120, a network 150, and a server proxy 145. The web service 160 is described by a WSDL document. To avoid client application 110 from having to implement WSDL-specific syntax and associated complexities, the subject matter herein relates to one or more metamodels 130 and 140 implemented separate from the WSDL description of web service 160. In the implementation depicted in FIG. 1, the metamodels 130 and 140 provide an additional layer of abstraction, and thus decouple client application 110 (e.g., a client proxy generation application) and web service 160 (e.g., a server proxy generation application) from the specifics of WSDL. In particular, the metamodels 130 and 140 map WSDL statements to metamodel objects. The metamodel objects include methods and data, are callable through an interface, such as an Application Program Interface (API), and then used to generate client proxy 120 and server proxy 140.

At runtime, the client proxy 120 (generated based on the metamodel 130 including metamodel objects) is used in conjunction with client application 110 to interact with web service 160. From the perspective of client application 110, it calls client proxy 120 without regard to WSDL or its syntax (e.g., the proxy has interpreted the WSDL statements and stored them in a form other than WSDL, such as in the form of generated classes and datatypes), and the generated client proxy 120 then calls web service 160 using a message formatted according to WSDL.

On the server side, at runtime, the server proxy 145 (generated based on the metamodel 140 (including metamodel objects) is used in conjunction with web service 160 to interact with client application 110. From the perspective of web service 160, it calls server proxy 145 without regard to WSDL or its syntax, and the server proxy 145 then calls client application 110. In some implementations, the use of metamodels 130 and 140 to create client proxy 120 and server proxy 145 simplify proxy generation, or an application when it communicates to the web service without using a proxy (i.e. a generic client).

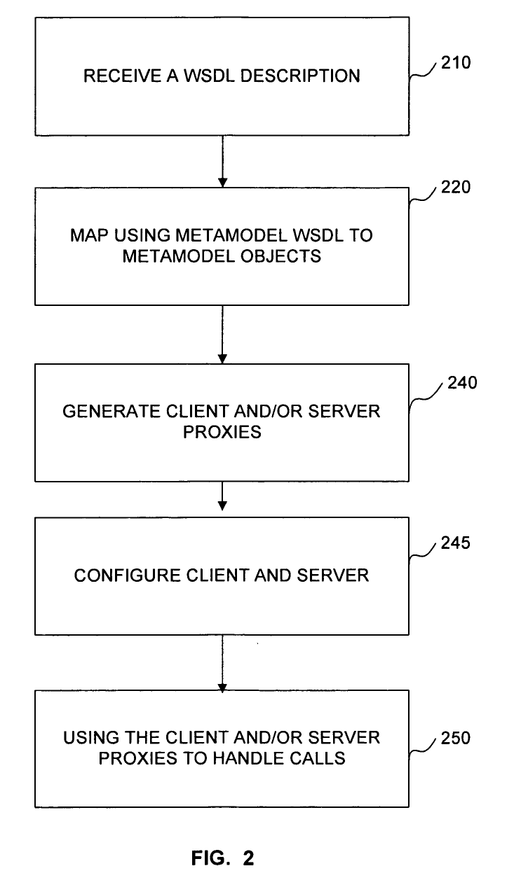

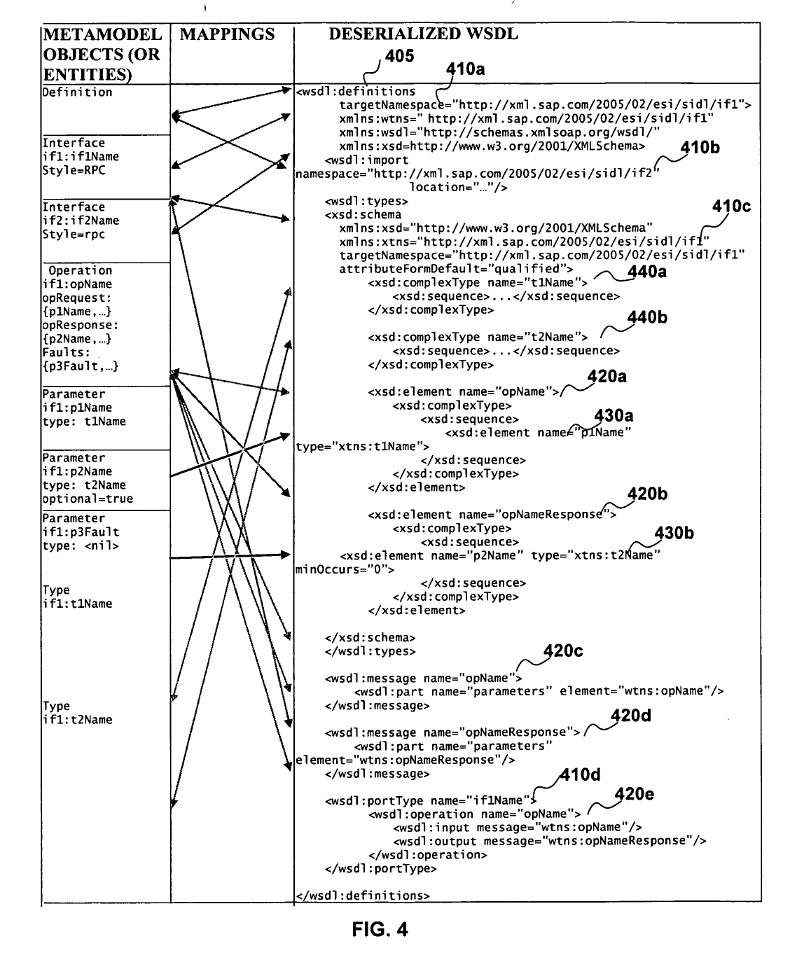

FIG. 2 depicts a method 200 for use with system 100. At 210, a WSDL description of web service 160 is received and deserialized. For example, during the design of client application 110, a WSDL description may be received describing web service 160. Deserialization decomposes the WSDL into the WSDL statements (e.g., in XML) depicted in the right hand column of FIG. 4. At 220, the WSDL statements are mapped to metamodel objects using metamodel 130 or 140. For example, WSDL statements are converted to metamodel objects (or entities), as described further below and depicted in FIG. 4. At 240, the client and server proxies 120 and 145 are generated using the metamodel objects of metamodels 130 and 140. At 245, the client and server are configured (e.g. to setup a security level). At 250, client application 110 calls client proxy 120, and client proxy 120 makes a WSDL-based call (e.g., sending a SOAP message formatted in accordance to the WSDL description of web service 160) through network 150 to server proxy 145, which converts the WSDL-based call to objects for use by web service 160.

Although the above description refers to using both a client proxy 120 and a server proxy 145, in some cases only one of the proxies 120 and 145 may be implemented in system 100.

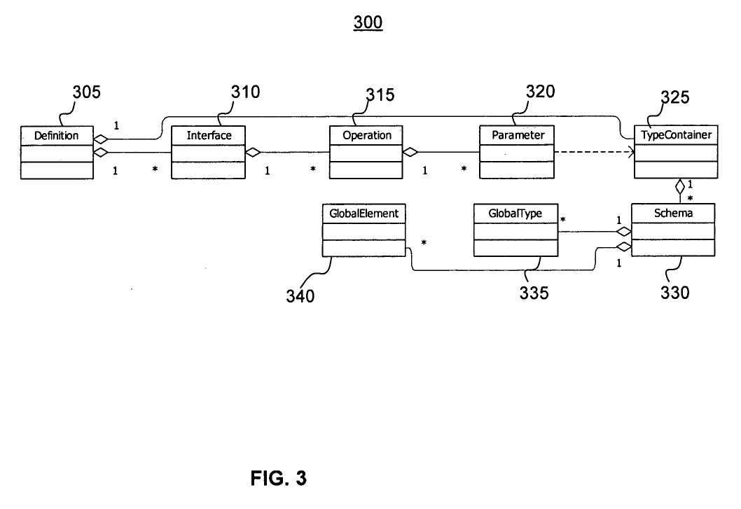

FIG. 3 depicts an example of a metamodel 300. The metamodel 300 may be implemented as metamodels 130 and 140 to decouple client proxy generation 120 and web service proxy generation 145 from the specific properties, implementation, and variations (e.g., versioning, extensions and, for example, WSDL-style) associated with a descriptor language, such as WSDL 1.1, used to describe and implement the web service.

The metamodel 300 includes the following entities (or objects): a definition 305, an interface 310, an operation 315, a parameter 320, a types container 325, a schema 330, a global type 330, and a global element 340. An entity is a single object, which can be modeled using entity-relationship diagrams.

The definition 305 functions as a so-called “root” for metamodel 300. The definition 305 may include one or more interfaces 310, a single type container 325, and methods to instantiate interfaces 310. A definition 305 may include interfaces 310 having multiple namespaces.

In some implementations, the definition 305 maps to the following WSDL statements: <wsdl:definitions> and <wsdl:import>'s depending on the namespaces of the underlying metamodel interfaces. FIG. 4 depicts an example of mappings performed by the metamodel 300. The mappings, described further below, convert WSDL statements (right column) to metamodel objects (left column) and vice versa.

Referring again to FIG. 3, the interface 310 may include zero or more operations 315 and corresponding methods to instantiate the operation entities. Moreover, one or more interfaces 310 (also referred to as “MM_interface”) may be associated with (or included within) definition 305. The interface 310 may refer to a plurality of operations 315. The interface 310 may be identified by its qualified name (Qname). The namespace of interface 310 within definition 305 may be different from the namespaces of other interfaces within definition 305. Moreover, interface 310 may be defined to have a style property to define either an RPC-based style or a document-based style.

In some implementations, interface 310 may be mapped into the following WSDL and XSD (XML Schema Definition) statements:

<wsdl:definitions
targetNamespace=”MM_Interface:Qname:Namespace”;
<wsdl:import namespace=
”Another_MM_Interface:Qname:Namespace”> ;
<xsd:schema targetNamespace=”MM_Interface:Qname:Namespace”>;
<wsdl:portType name=”MM_Interface:Qname:NCName”>,

where “MM_Interface:Qname:Namepace” represents the Qname namespace for the interface 310, and “MM_Interface:Qname:NCName” represents the unqualified name (NCName) of the interface 310. Examples of the above mappings are depicted in FIG. 4 at 410a-d. For each interface, there might be an associated schema, which has the same target namespace as the interface. The schema may be used for the element declarations of the operation request and/or response, when metamodel document-style is specified.

The model 300 may include zero or more operations 315 (also referred to as MM_operation) within an interface 310. The operation may be identified by a Qname, but the Qname namespace should be the same as the Qname namespace of interface 310. The operation 315 may map to the following WSDL:

<wsdl:operation name=“MM_Operation:Qname:NCName”>,

where ““MM_Operation:Qname:NCName” represents the NCName of the operation 315.

The request part of the operation 315 may be mapped to the following WSDL in the document-style:

<wsdl:message
name=”MM_Operation:Request:Qname:NCName”>;
<wsdl:input message=”MM_Operation:Request:Qname:NCName”>
<wsdl:part name=’parameters’
element=”MM_Operation:Request:Qname’/>
<xsd:element name=’MM_Operation:Request:Qname:NCName’>

The response part of the operation 315 may be mapped to the following WSDL in the document-style:

<wsdl:message
name=”MM_Operation:Response:Qname:NCName”>;
<wsdl:output message=”MM_Operation:Response:Qname:NCName”>;
<wsdl:part name=’parameters’
element=”MM_Operation:Response:Qname”’/>;
<xsd:element name=”MM_Operation:Response:Qname:NCName”>

Examples of the above operations are depicted in FIG. 4 at 420a-e.

The operation 315 may be associated with one or more corresponding parameters 320. The parameters 320 may have a unique name within its scope (e.g., an input parameter may have a unique qualified name within the scope of all input parameters, while another parameter may be unique merely within the scope of operation 315). The parameter 320 may also be qualified as optional. The parameters 320 may refer to a global type defined in a schema container 330. A type container is used to hold and organize schemas. The schema container 330 is an abstraction representing different schema types, for example the XSD schemas. The XSD is a schema (or model) which is used to describe the structure of information and to enable validation of data in an XML environment. The schema container 330 may contain global types and global elements, which may refer to each other. The schema may also refer to the types and elements from other namespaces. FIG. 4 at 430a-b depicts examples of mappings between parameters 320 and WSDL.

The global type 335 may correspond to any type (also referred to as a data type) including XSD types, such as a simple type or a complex type. The global element 340 may correspond to an element declaration including an XSD element. A global element identifies an element declaration available for use in content models throughout the metamodel 300. For example, in case of WSDL, only global elements (and types) can be used in WSDL message declarations. FIG. 4 at 440a-b depicts examples of mappings between global type 335 and WSDL

Although the above describes mapping entities of metamodel 300 to WSDL1.1 and XSD1.0, any other language may be used instead. Moreover, although the above describes a web service, any other program or application may be used instead. Moreover, the metamodel 300 may enable the use of common entities 305-340 as well as common mapping rules for those entities to WSDL.

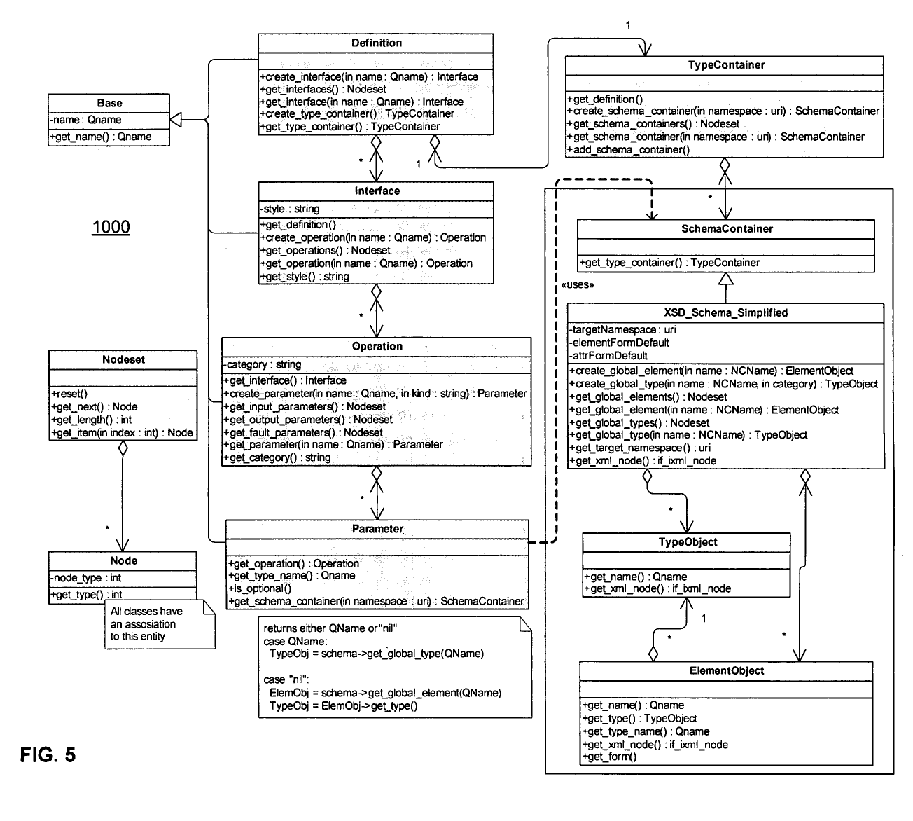

FIG. 5 depicts another example of a metamodel model 300 implemented specifically for a SAP ABAP environment. The metamodel 1000 may be used to generate metamodel objects from WSDL.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

What is claimed is:

1. An article comprising a machine-readable medium embodying instructions that when performed by one or more machines result in operations comprising:
mapping, using a metamodel, one or more WSDL statements associated with a web service to one or more metamodel objects; and
using the one or more metamodel objects to generate a proxy without regard to a version associated with the one or more WSDL statements and a syntax associated with the one or more WSDL statements.

2. The article of claim 1 further comprising:
using the one or more metamodel objects to generate the one or more WSDL statements.

3. The article of claim 2 further comprising:
generating the one or more WSDL statements of a predetermined version and of a predetermined type definition.

4. The article of claim 3 further comprising:
defining the predetermined type definition as an XSD schema.

5. The article of claim 1 further comprising:
generating the proxy as a client proxy without regard to the version associated with the one or more WSDL statements and the syntax associated with the one or more WSDL statements.

6. The article of claim 1 further comprising:
generating the proxy as a server proxy without regard to the version associated with the one or more WSDL statements and the syntax associated with the one or more WSDL statements.

7. The article of claim 1 further comprising:
providing the metamodel comprising the following entities: a definition entity, an interface entity, an operation entity, a parameter entity, and a type system entity.

8. A computer-implemented method comprising:
mapping, using a metamodel, one or more WSDL statements associated with a web service to one or more metamodel objects; and
using the one or more metamodel objects to generate a proxy without regard to a version associated with the one or more WSDL statements and a syntax associated with the one or more WSDL statements.

9. The computer-implemented method of claim 8 further comprising:
using the one or more metamodel objects to generate the one or more WSDL statements.

10. The computer-implemented method of claim 9 further comprising:
generating the one or more WSDL statements of a predetermined version and of a predetermined type definition.

11. The computer-implemented method of claim 10 further comprising:
defining the predetermined type definition as an XSD schema.

12. The computer-implemented method of claim 8 further comprising:
generating the proxy as a client proxy without regard to the version associated with the one or more WSDL statements and the syntax associated with the one or more WSDL statements.

13. The computer-implemented method of claim 8 further comprising:
generating the proxy as a server proxy without regard to the version associated with the one or more WSDL statements and the syntax associated with the one or more WSDL statements.

14. The computer-implemented method of claim 8 further comprising:
providing the metamodel comprising the following entities: a definition entity, an interface entity, an operation entity, a parameter entity, and a type system entity.

15. A system comprising:
a processor; and
a memory, wherein the processor and the memory are configured to perform a method comprising:
mapping, using a metamodel, one or more WSDL statements associated with a web service to one or more metamodel objects; and
using the one or more metamodel objects to generate a proxy without regard to a version associated with the one or more WSDL statements and a syntax associated with the one or more WSDL statements.

16. The system of claim 15 further comprising:
using the one or more metamodel objects to generate the one or more WSDL statements.

17. The system of claim 16 further comprising:
generating the one or more WSDL statements of a predetermined version and of a predetermined type definition.

18. The system of claim 17 further comprising:
defining the predetermined type definition as an XSD schema.

19. The system of claim 15 further comprising:
generating the proxy as a client proxy without regard to the version associated with the one or more WSDL statements and the syntax associated with the one or more WSDL statements.
